(19) United States
(12) Patent Application Publication
(10) Pub. No.: US 2023/0288278 A1
(43) Pub. Date: Sep. 14, 2023

(54) PRESSURE SENSING

(71) Applicant: Hewlett-Packard Development Company, L.P., Spring, TX (US)

(72) Inventors: Miquel BOLEDA BUSQUETS, Sant Cugat del Valles (ES); John DORAN, Sant Cugat del Valles (ES); Jose Francisco BRAVO DE VEGA, Sant Cugat del Valles (ES)

(73) Assignee: Hewlett-Packard Development Company, L.P., Spring, TX (US)

(21) Appl. No.: 18/007,215

(22) PCT Filed: Jul. 31, 2020
(86) PCT No.: PCT/US2020/044552

§ 371 Date: Jan. 27, 2023

(51) Int. Cl. G01L 9/00; G01L 9/14; B41J 2/175

(52) U.S. Cl. CPC G01L 9/007; G01L 9/14; B41J 2/17566

(57) ABSTRACT

An example printing fluid pressure sensor comprises a first pressurizable chamber having an inlet to receive a pressurized gas and a second chamber to receive a printing fluid. A flexible element is disposed in between the first and second chambers and is to retain a magnet. A first side of the flexible element forms a wall of the first chamber and a second side of the flexible element forms a of the second chamber to seal the first and second chambers. The example sensor further comprises a sensor to detect the position of a magnet relative to the sensor. The sensor is disposed outside of the first and second chambers.

### BACKGROUND

Fluid pressure may be measured in industrial or domestic applications where fluids are used or warehoused.

### BRIEF DESCRIPTION OF DRAWINGS

Examples will now be described, by way of non-limiting example, with reference to the accompanying drawings, in which:

FIG. 1 is a simplified schematic cross section through an example printing fluid pressure sensor;

FIG. 2 is a simplified schematic cross section through an example pressure sensor;

FIG. 3 is a simplified schematic cross section through an example device;

FIG. 4a is a perspective view of an example device

FIG. 4b is an exploded view of the example device of FIG. 4a;

FIG. 4c is a plan view of an example membrane;

FIG. 4d is a cross section through the example device of FIG. 4a;

FIG. 5 is a perspective view of an example device;

FIG. 6a is a perspective view of an example device;

FIG. 6b is a plan view of an example membrane; and

FIG. 6c is a cross-section through a portion of the example device of FIG. 6a.

### DETAILED DESCRIPTION

Some examples herein relate to a device (for example, a pressure sensing device), or a sensor, to measure the pressure of a fluid, such as a printing fluid (e.g. comprising an ink), comprising two chambers separated by a flexible element (which may comprise a membrane or resiliently deformable element). The flexible element may comprise a resiliently deformable material, for example synthetic rubber and may be to hold or retain a magnetic element such as a magnet. For this purpose, the flexible element may comprise a pocket, cavity, or recess for retaining the magnetic element. The two chambers of the device may each be for receipt of a fluid and in some examples two different fluids may be received in each respective chamber. For example, one chamber may be for receipt of a gas (for example, air), such as a pressurized gas (e.g. pressurized air) and the other chamber may be for receipt of a fluid of which the device is to measure the pressure (for example, a liquid, such as a printing fluid). In this way the flexible element which separates the two chambers is exposed to the pressure of a fluid in each chamber such that the fluid in either chamber may exert a force on the flexible element (and vice-versa), and any magnetic element retained thereby or therein. For example, a first side of the flexible element may form a wall of, or define, the first chamber and/or a second side of the flexible element may form a wall of, of define, the second chamber.

The flexible element comprises an equilibrium or quiescent (rest) position and the flexible element may move about this position due to the pressure difference across the flexible element. The magnet, retained by the membrane, therefore also comprises an equilibrium or quiescent (rest) position and is caused to move about this position due the pressure difference across the flexible element (and therefore across the magnet). The equilibrium position of the element and magnet may be the position which they naturally adopt following the manufacture of the device. As the pressure differential changes across the flexible element (for example, due to a changing pressure a fluid in the first and/or second chamber) the corresponding change in force exerted on the membrane may be translated into motion (e.g. linear motion) of the flexible magnet (e.g. about its equilibrium position), which is thereby translated into motion (e.g. linear motion) of a magnet retained by the flexible element. For example, if the membrane is to separate first and second chambers of the device into a top and bottom chamber (referring to an orientation of the device in use) then any changes (e.g. rises and falls) in pressure may cause the flexible element to move up and/or down or closer to and/or further away from a top of the device (for example, a lid of the device in examples where the device comprises a lid). In these examples the movement of the flexible element and magnet due to the pressure changes may be vertical and one chamber may be defined by the flexible element at a top of the chamber with the other chamber being defined by the flexible element at a bottom of the chamber. In these examples, the chamber to contain pressurized gas (e.g. air) and this chamber may be located at a top of the device with the flexible element being to retain a magnet such that the magnet is exposed to this top chamber.

The devices herein comprise a sensor to detect movement of the magnet by converting the distance between the sensor and the magnet to an electrical signal. More specifically, the magnetic field produced by the magnet will induce a voltage (or current) in the sensor and as the strength of the magnetic field at the sensor will vary depending on the position of the magnet the voltage (or current) signal produced by the device will also vary depending on the position of the magnet. The sensor may be to output this signal, e.g. to another module such as a controller. In this way, the sensor is able to output an electrical reading directly proportional to the distance that the magnet has moved, and this reading may in turn be used to determine the differential pressure across the flexible element and/or the pressure of a fluid in one of the chambers of the device. In this way, the device may be to determine the pressure of a fluid by receiving that fluid in one of the chambers and measuring the effect this has on the position of the magnet by examining the electrical signal determined by the sensor. The sensor may comprise a Hall effect sensor. In this way, the sensor measurement may be based on the voltage, e.g. potential difference, passing through a plate of the sensor (e.g. a voltage variation).

In one example a gas (e.g. pressurised gas) is received in a first chamber of the device and a fluid (e.g. a printing fluid) whose pressure is to be measured is received in the second chamber. The movement of the flexible element may be moderated by changing the pressure of the gas in the first chamber thus applying more or less pressure to the flexible element. If the gas in the first chamber is kept at ambient pressure than the direct pressure of the fluid in the second chamber may be measured directly (from the signal of the sensor) but if the pressure is different to ambient then the pressure across the flexible element may be measured (from the signal of the sensor) and the pressure of the fluid in the second chamber may be measure in this example indirectly. The sensor for the magnet may be part of a printed circuit assembly (PCA) and the device may comprise the PCA.

The device may be calibrated to record a current or voltage level induced by the magnet when the magnet (and flexible element) are in their respective equilibrium positions. In this way, accurate measurements may be made taking into account manufacturing tolerances resulting in slightly different equilibrium positions of the magnet and flexible element since the sensor's measurements reflect changes in the magnet position about the equilibrium position. This may be used in examples where there are a plurality of pressure sensors, or sensing devices, as in these examples the position of each one of a plurality of magnets may be slightly different to that of another magnet in another device. In some examples, for calibrating the sensor, a plurality of values of voltage readings corresponding to given pressure inputs may be stored. In this way, not only a value indicating an equilibrium position of the flexible element may be stored (wherein, in some examples, the pressure in both chambers may be equal, which may correspond to a “zero” sensor reading), but also a plurality of other calibration pressure points may be stored with their corresponding voltage readings where the pressure in the lower chamber is lower than in the upper chamber 102 and viceversa. From this set of calibration values, any given voltage reading can be translated to a pressure reading. The plurality of calibration values may be stored in a lookup table. The plurality of calibration values may be stored in a sensor electronic memory, and the sensor reading can be directly measured in pressure units in a digital output line, where the conversion from voltage to pressure is calculated by a microprocessor of the sensor itself, from the stored calibration values. The sensor could be recalibrated over time, by exposing it to known pressure values and differentials between its chambers and obtaining the corresponding voltage readings in case they drift over time (e.g. due to material property changes such as flexible membrane rigidity, magnet field intensity or even some other external condition factor that could alter the voltage readings over time).

The flexible element may itself be calibrated in that changes to its thickness or geometry may affect its performance (movement in response to pressure changes) which effectively allows the flexible element to be “tuned” to different pressure ranges. For example, a thicker element and/or having a larger radius may resist higher pressures and may therefore be more suited to operating at higher pressures whereas a thinner element and/or having a smaller radius may be more suited to operating at lower pressures.

In some examples, the membrane may function as a seal for an inlet of one of the chambers. For example, the membrane, when in a first position (e.g. an extreme position) may function as a plug to seal the chamber inlet to prevent a return path of fluid in that chamber of the device. The membrane may be to hold that closed position until a pressure across the inlet became high enough again to raise the membrane and let the fluid enter the chamber. The chamber may be the fluid chamber and so in these examples the membrane may comprise a first position to seal an inlet of the fluid chamber and may be to hold that positon to seal the inlet until a pressure differential across the inlet exceeds a predetermined amount.

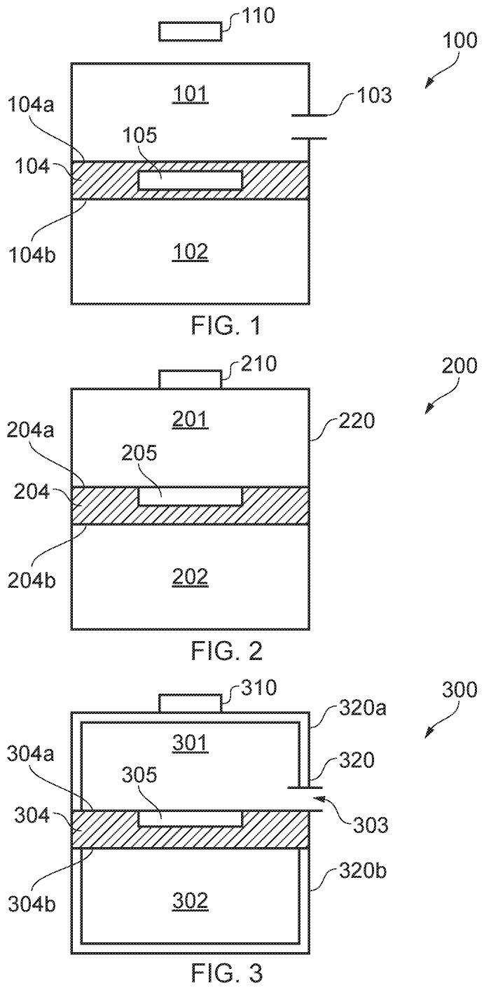

FIG. 1 shows an example printing fluid pressure sensor 100. The pressure sensor 100 according to this example comprises a first pressurizable chamber 101 and a second chamber 102. The first pressurizable chamber 101 comprises an inlet 103 to receive a pressurized gas. The inlet 103 may comprise a one-way valve to permit the entry into, but not the exit from, gas into the first chamber 101. The inlet 103 may comprise a luer connection or barbed-connection or one-way valve etc. for example to permit the ingress and prevent the egress of gas. For example, the connection may comprise a protrusion or flange (e.g. a circumferential protrusion) to connect the inlet to a source of fluid via an interference, or press, fit. The sensor 100 comprises a flexible element 104 disposed in between the first and second chambers 101, 102. The flexible element 104 comprises a first side 104a and a second side 104b. The first side 104a of the flexible element 104 forms a wall of the first chamber 101 and the second side 104b of the flexible element 104 forms a wall of the second chamber 102, the flexible element 104 sealing the first and second chambers 101, 102. The first and second chambers 101, 102 are therefore each defined, at least in part, by the flexible element 104. The flexible element 104 is to retain a magnet (indicated at 105). The pressure sensor 100 also comprises a sensor 110 to detect the position of a magnet (for example, magnet 105 retained by the flexible element 104) relative to the sensor 110. As indicated in FIG. 1, the sensor 110 is disposed outside of the first and second chambers 101,102.

The magnet 105 is retained in the flexible element 104, e.g. by being held in a recess (or pocket or cavity). As shown in FIG. 1, the recess is provided in the flexible element 104 to retain the magnet 105 therein but in other examples the recess to retain the magnet may be provided on one side of the flexible element 104 (see the example of FIG. 2). For example, the recess in the flexible element 104 may be located on the first side 104a of the flexible element 104 to retain the magnet 105 such that the recess is not exposed to the second chamber 102 such that, when a magnet 105 is received in the recess and when printing fluid is received in the second chamber 102, the magnet 105 and printing fluid are not in contact. The recess may be exposed to the first pressurizable chamber 101. In this way, the magnet 105 may not be in contact with the second chamber 102 (and any printing fluid contained therein) but may be in contact with the first chamber 101 (and any fluid, e.g. gas contained therein).

In the FIG. 1 examples, the sensor 110 is disposed about the printing fluid sensor 100 such that the first chamber 101 is in between the sensor 110 and the flexible element 104. Therefore, in this example, the sensor 110 is disposed such that the first chamber 101 is in between the magnet 105 (when the magnet 105 is received in the flexible element 104) and the flexible element 104. In this way, when there are pressure changes across the flexible element 104 the magnet 105 may move up and/or into the first chamber 101. When the first chamber 101 is filled with a gas, such as a pressurised gas (e.g. pressurised air), an increase in the pressure in a printing fluid in the second chamber 102 will cause the magnet 105 move upwards, acting against the pressure exerted against the magnet 105. As stated above, these movements of the magnet 105 cause changes in a surrounding magnetic field which are detected by the sensor 110.

The sensor 110 may comprise a Hall effect sensor as described above. As shown in FIG. 1, the sensor 110 is external to the chambers 101 and 102. For example, if the device comprises a lid (e.g. a plastic lid) then the sensor 110 may be external to the plastic lid of the device. As will be described below, in some examples the device 100 may comprise a PCA (not shown in FIG. 1) and the PCA may comprise the sensor 110. In these examples, the PCA may be external to the first and second chambers 101, 102. Referring to the orientation in which the sensor 100 is depicted in FIG. 1, the first chamber 101 may comprise an upper, or top, chamber. The first chamber 101 may therefore comprise an upper housing. The second chamber 102 may comprise a lower, or bottom, chamber. The second chamber 102 may therefore comprise a lower housing. In this example the second chamber 102 is therefore defined at the top by the flexible element 104 and the first chamber 101 is defined at the bottom by the flexible element 104. The first chamber 101 may contain a gas (e.g. air) and the second chamber 102 may contain a fluid (e.g. a liquid such as printing fluid) whose pressure is be measured by the sensor 100. Therefore, in one example a liquid whose pressure is to be measured is located in the lower chamber 101 of the sensor 100 and a gas is located in the upper chamber 102, the pressure exerted from the fluid is then exerted upward onto the second face 104b of the flexible element 104 causing a linear displacement of the flexible element 104 upwards and towards and/or into the first chamber 101. In some examples the walls of the chamber 101 and/or 102 may comprise a resiliently deformable or flexible material (for example they may comprise rubber or plastic) enabling the chambers to be flushed clean and easily filled with a different fluid (e.g. a different liquid whose pressure is to be measured).

FIG. 2 shows an example pressure sensor 200 for determining the pressure of a printing fluid. The pressure sensor 200 of this example comprises a housing 220 and a membrane 204 disposed at least partially inside the housing 220. The membrane 204 separates a first chamber 201 and a second chamber 202. The membrane 204 comprises a first side 204a and a second side 204b and the membrane 204 separates the first and second chambers 201, 202 on respective sides 204a, 204b of the membrane 204. The first chamber 201 comprises a pressurizable chamber for receipt of a pressurized gas and the second chamber 202 comprises a printing fluid chamber for receipt of a printing fluid. The membrane 204 is to retain a magnetic element (schematically indicated at 205). The pressure sensor 200 further comprises a magnetic field sensor 210 which is shown disposed on the housing 220. The magnetic field sensor 210 is to detect movement of a magnet (such as the magnet 205).

Like the example of FIG. 1, in the example of FIG. 2, the pressure sensor 200 is to retain the magnetic element 205 magnetic element such that the magnetic element is not exposed to the second chamber 202. Unlike the example of FIG. 1, in the example of FIG. 2, the magnetic field sensor 210 is disposed on the side of the membrane 204 facing the first chamber 201. The membrane 204 of this example may comprise a cavity to retain the magnetic element 205 such that the magnetic element is not exposed to the second chamber 202.

As for the sensor 100 of FIG. 1, the sensor 210 of the sensor 200 may comprise a Hall effect sensor as described above. Additionally the sensor 210 is external to the chambers 201 and 202 but unlike the FIG. 1 example the sensor 210 is shown attached to, or part of, a housing 220 of the first chamber 201. As for the FIG. 1 sensor 100, in some examples the sensor 200 may comprise a PCA (not shown in FIG. 1) and the PCA may comprise the sensor 210, for example the PCA may be attached to the housing 220. As for the FIG. 1 example, the first chamber 201 may comprise an upper, or top, chamber and the second chamber 202 may comprise a lower, or bottom, chamber, the second chamber 202 therefore being defined at the top by the membrane 204 and the first chamber 201 being defined at the bottom by the membrane 204. The first chamber 101 may contain a gas (e.g. air) and the second chamber 102 may contain a fluid (e.g. a liquid such as printing fluid) whose pressure is be measured by the sensor 100. Also, as for the FIG. 1 example, in some examples the housing 220 may comprise a resiliently deformable or flexible material (for example they may comprise rubber or plastic) enabling the chambers to be flushed clean and filled with a different fluid.

FIG. 3 shows an example pressure sensing device 300 for printing fluid. The device 300 of this example comprises a pressurizable gas chamber 301 for receipt of a pressurized gas and a printing fluid chamber 302 for the receipt of printing fluid. The device 300 comprises a resiliently deformable element 304 that separates the gas chamber 301 from the printing fluid chamber 302, the resiliently deformable element 304 (hereafter “element” 304) comprising a first side 304a and a second side 304b. The pressure sensing device 300 also comprises a device housing 320 comprising a first housing portion 320a and a second housing portion 320b. The first and second housing portions 320a, 320b may comprise upper and lower housing portions of the device, respectively. The first housing portion 302a comprises an inlet 303 to receive pressurized gas. The inlet 303 may comprise a one-way valve to permit the entry into, but not the exit from, gas into the first chamber 301. The inlet 303 may comprise a luer connection or barbed-connection or one-way valve etc. for example to permit the ingress and prevent the egress of fluid. The first side 304a of the element 304 and the first housing portion 302a form (e.g. at least partially define) the gas chamber 301 and the second side 304b of the element 304 and the second housing portion 302b form (e.g. at least partially define) the printing fluid chamber 302. The resiliently deformable element 304 is to hold a magnetic element (schematically indicated at 305). The pressure sensing device 300 comprises a sensor 310 which is to detect movement of the magnetic element 305.

In the FIG. 3 example, the housing 320 comprises the sensor 310. More specifically, the first housing portion 320a (the portion 320a defining, at least in part, the first chamber 301) comprises the sensor 310. However, as for the FIGS. 1 and 2 examples the sensor 310 is located such that the first pressure chamber 301 is in between the sensor 310 and the magnetic element 305. In this way, as for the sensors 100 and 200, the magnet 305 is movable into the first chamber 301 toward the sensor 310. In the FIG. 3 example, as for the FIG. 2 example, the first side 304a of the resiliently deformable element 304 comprises an opening to hold the magnetic element 305.

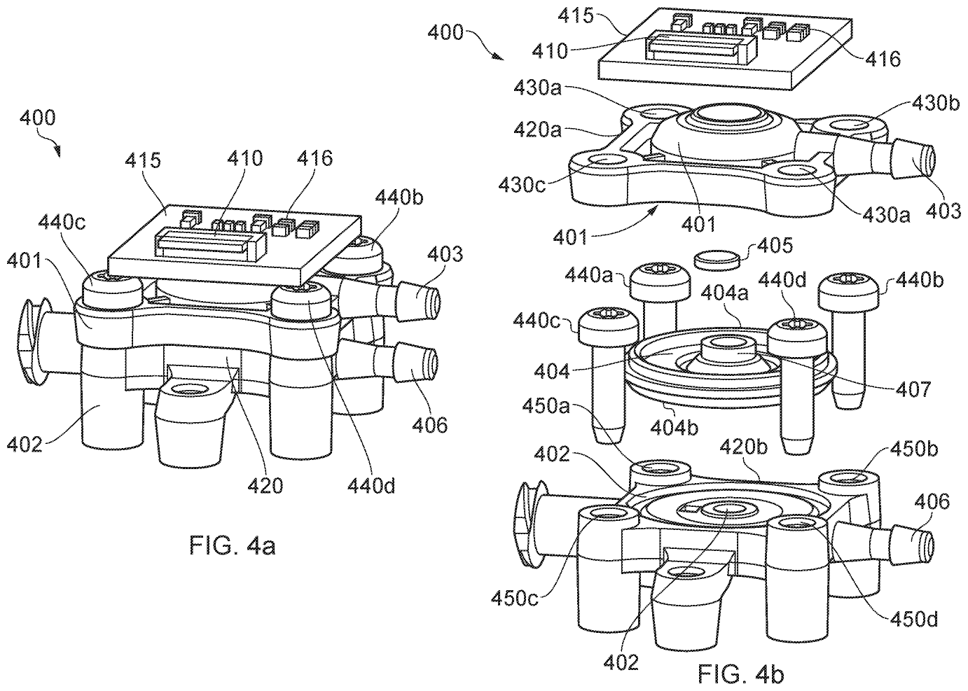

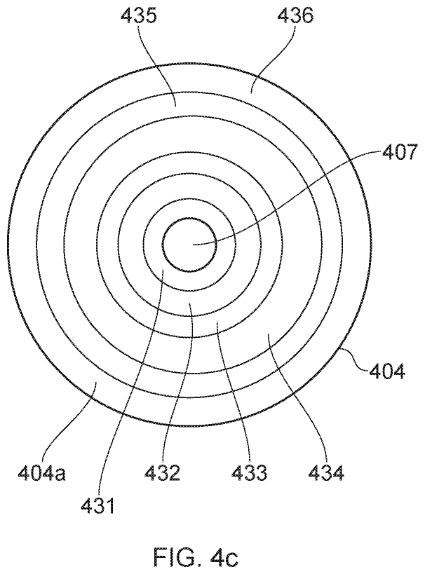

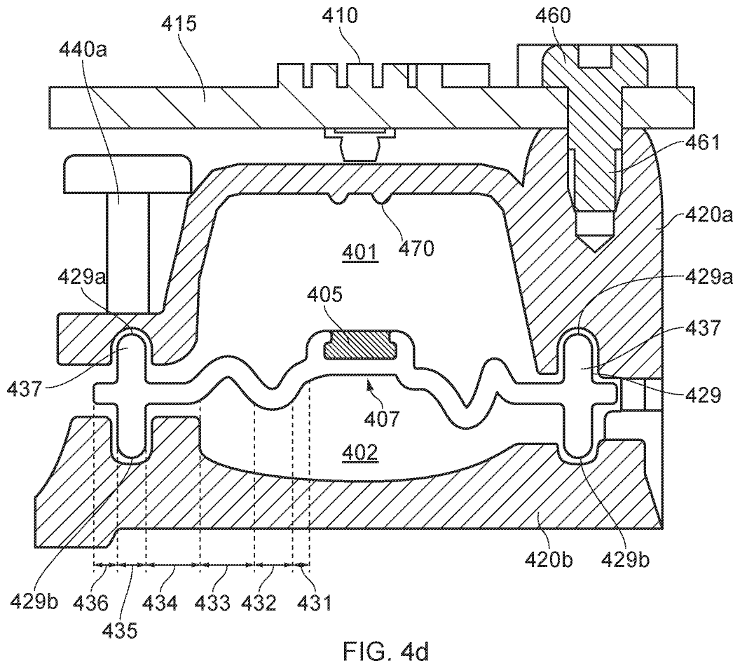

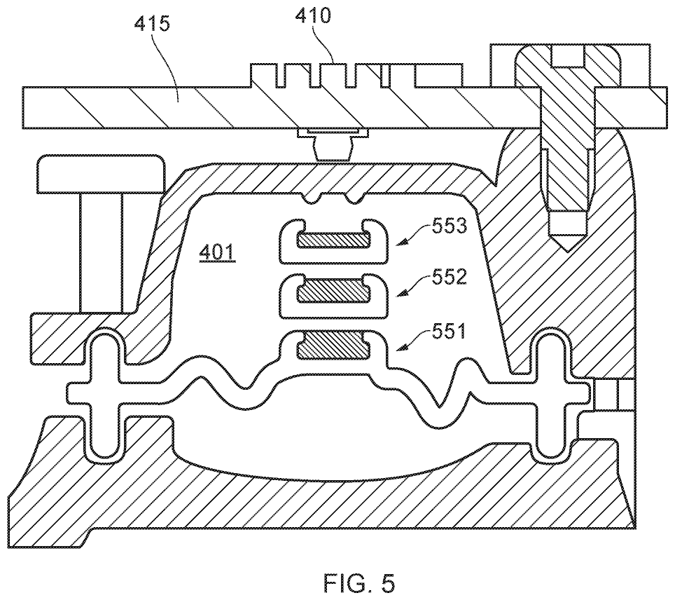

FIGS. 4a and 4b respectively show a perspective view and an exploded view of an example device 400. The device 400 may comprise the sensor 100, the sensor 200 or the device 300 as described above with respect to FIGS. 1-3, respectively, and, accordingly, like features will be denote by like reference numerals. The device 400 comprises a first, upper, chamber 401 for receipt of a gas (e.g. air), e.g. pressurized gas and a second, lower, chamber 402 for receipt of a fluid (e.g. a liquid) whose pressure is to be sensed by the device 400. The device 400 comprises a flexible membrane 404 (visible in the exploded view of FIG. 4b but not visible from the exterior of the assembled device 400) which comprises a pocket (or cavity or recess etc.) 407 to retain a magnet 405. The first chamber 401 comprises an inlet 403 which may comprise a luer connection (or barbed-connection or one-way valve etc. to permit the ingress but prevent egress of a fluid) to a source of gas to be directed via the inlet 403 into the chamber 401. The device 400 comprises a device housing 420 which comprises a first housing portion 420a for the first chamber 401 and a second housing portion 420b for the second chamber 402. The first housing portion 420a may comprise the inlet 403. The housing 420 may comprise the membrane 404 in that the membrane 404 may define, at least in part, the housing 420 of the device. For example, the first chamber 401 in this example is defined by the first housing portion 420a forming walls of the housing 420 and a first, upper, side 404a of the membrane 404 defines a floor, or bottom surface, of the first chamber 401. The second chamber 402 in this example is defined by the second housing portion 420b forming walls of the housing 420 and a second, lower, side 404b of the membrane 404 may define a ceiling, or top surface, of the second chamber 402. As shown in the exploded view, the membrane pocket 407 is located in the first surface 404a of the membrane such that the magnet 405, when received in the pocket 407, faces, and is exposed to any fluid in, the first chamber 401. The second chamber 402 also comprises an inlet 406 which may comprise a luer connection (or barbed-connection or one-way valve etc. to permit the ingress but prevent egress of a fluid) to a source of fluid, e.g. printing fluid, to be directed via the inlet 406 into the chamber 402. The second housing portion 420b may comprise the inlet 406.

The first housing portion 420a is open at the bottom (the first side 404a of the membrane 404 forming the bottom surface of the first chamber 401 in this example) and the second housing portion 420b is open at the top (the second side 404b of the membrane 404 forming the top surface of the second chamber 402 in this example) and the membrane 404 is to be received therebetween. In the FIG. 4 example, four fasteners 440a-d are provided to secure the first and second housing portions 420a, 420b together with the membrane 404 therebetween to form the housing 420 of the device, and to form the device 400. In this example the first housing portion 420a comprises holes 430a-d, each hole being for the receipt of a respective fastener 440a-d, and the second housing portion 420b comprises holes 440a-d, each hole being for the receipt of a respective fastener 440a-d such that the fasteners 440a-d secure the two housing portions 420a,b together to form the device housing 420. The fasteners 440a-d may comprise screws or nails or pins etc. Although four are depicted any number of fasteners may be used. The device 440 comprises a PCA 415 which comprises a sensor 410 which may comprise a Hall effect sensor as described above. The PCA 415 of this example also comprises another electronic component, schematically indicated at 416, which may for example comprise a memory and/or a processor and/or a storage and/or a controller. The PCA 415 and the further component 416 will be described in more detail with reference to FIG. 4d.

FIG. 4c shows a plan view of an example membrane 404. FIG. 4c shows a view of the first, or upper, surface 404a of the membrane 404 and accordingly shows the recess 407 of the membrane to retain the magnet 405 (which is not shown in FIG. 4c). The recess 407 in this example is substantially circular, or comprises substantially circular cross sections. The recess 407 is located substantially in the centre of the membrane 404. The membrane 404 in this example is substantially disc-shaped. FIG. 4c shows that the membrane 404 comprises a geometry that divides the membrane 404 into a plurality regions 431-436 and 407, e.g. first to sixth regions 431-436 and the recess 407. The regions 431-436 are annular in shape and are spaced circumferentially about a centre of the membrane 404.

FIG. 4d shows a cross-section through the device 400 showing the circumferential regions 431-436 of the membrane 404. Starting at the centre of the membrane 404 and working circumferentially outwards, the membrane comprises first to sixth regions 431-436. The first 431, fourth 434, and sixth 436 regions have substantially the same height. The second region 432 comprises a depressed region having a lower height than the first region 431. The third region 433 comprises a raised region having a higher height than the first region 431 and the second region 432. The fifth region 435 comprises a protrusion 437 (or flange 437) of the membrane 404. As seen in FIG. 4d, the housing comprises a recess 429 (or groove 429) to receive the protrusion 437 of the membrane 404. In this example, the protrusion 437 comprises a circumferential protrusion 437 comprising a first protruding part 437a and a second protruding part 437b, each protruding part 437a, 437b protruding outwardly from the membrane 404 with the first protruding part 437a extending axially outwardly from the first side 404a of the membrane 404 and the second protruding part 437b extending axially outwardly from the second side of the membrane 404. In these examples, the first housing portion 420a comprises a first recess 429a and the second housing portion 420b comprises a second recess 429b. The first recess 429a in the first housing portion 420a is to receive the first protruding part 437a and the second recess 429b in the second portion 420b is to receive the second protruding part 437b. In other the examples the membrane 404 may comprise one protruding part and the housing (e.g. the first or second housing portion) may comprise one corresponding recess. The recess may be complementarily sized and/or shaped to receive the protrusion. In this way, and as shown in FIG. 4d, when the fasteners secure the two housing portions together, the membrane 404 is sealed in between the housing portions. In this example, the engagement between the membrane 404 and the housing 420 may be via engagement between the protrusion 437 and recess 429, and this may form a water-tight or hermetic etc. seal such that no fluid in the first chamber 401 and/or second chamber 402 may escape the device 400.

Shown in FIG. 4d, the device comprises a fastener 460 to secure the PCA 415 to the housing 420. The first housing portion 420a may comprise a hole 461 to receive the fastener 460 to secure the PCA 415 to the device via the first housing portion 420a. In other examples, the PCA 415 may be secured to the housing 420 via the second housing portion 420b or via another means. As best seen in FIG. 4, the cavity 407 of the membrane 404 comprises a circumferential flange to retain the magnet 405 by a snap fit, although in other examples the membrane 404 may retain the magnet 405 by another means (e.g. the magnet may be attachable to the membrane, for example releasable attachable etc.). In this example a gap exists between the housing 420 and the PCA 415 which may allow for a tolerance between these components however the sensor 410 may be calibrated to account for such tolerances.

Also shown in FIG. 4d, the first housing portion 420a comprises a protrusion 470 to prevent a magnet 405 retained by the membrane 407 from being ejected from the pocket 407 of the membrane 405 as the membrane is caused to move to an extreme position (e.g. see positon 553 in FIG. 5) under high pressure differentials. In the FIG. 4d example, the protrusion 470 is depicted as a circumferential groove but in other examples the protrusion may be of a different shape. The protrusion may comprise a downwardly protruding element (having regard to the orientation depicted in FIG. 4d which may be regarded as an orientation the device is to adopt in use in some examples), for example a protruding tab, flange, or groove etc.

FIG. 5 shows a perspective view through the device 400 showing various positions of the magnet 405, corresponding to various displacements of the membrane 404 due to different pressures across the membrane. For example, FIG. 5 shows three such positions labelled 551, 552 and 553 with 551 illustrating the equilibrium, or quiescent, position of the membrane 404 and magnet 405. The positions labelled 552 and 553 correspond to an increased fluid pressure in the chamber 402 such that the pressure of a fluid (e.g. a printing fluid) in the chamber 402 may be increased so as to displace the membrane 404 to the position labelled 552 and further increased so as to displace the membrane 404 to the position labelled 553. The sensor 410 may be calibrated such that the equilibrium position 551 corresponds to a current measurement of 0 mA. In some examples, the current measurement from the sensor 410 when the magnet 405 is in the equilibrium position 551 may be recorded as the “rest” current (for example may be written to a memory, e.g. a memory 416 on the PCA). The position 553 may comprise a maximal displacement of the membrane 404, the maximal displacement and position 552 may therefore define a maximal displacement of the magnet 405, although the movement of the membrane 404 and its maximal displacement may be changed by altering the properties of the membrane 404 such as its composition and/or geometry (e.g. thickness). For example, different membranes 404 may be used in this way to allow for different pressure ranges. In some examples a positive pressure in the chamber 402 may push the magnet 405 to one of the positions 552 or 553 into the chamber 401 whereas a negative pressure may cause the magnet 405 to be pulled (downwards in the FIG. 5 orientation) into the chamber 402.

In one example use, the inlet 403 of the first chamber 401 may be connected to a supply of printing fluid in an environment surrounding a bag filled with the printing fluid. In this example the first chamber 403 may receive the air surrounding the printing fluid bag. This air may be at atmosphere but may also be at a non-atmospheric pressure. The inlet 406 of the second chamber 402 may be connected to the printing fluid inside the bag. In this way, when the air is received in the chamber 401 and the fluid is received in the chamber 402 the pressure differential across the membrane 404 mimics the pressure differential across the printing fluid bag. Through the current measurement determined by the sensor 410 the pressure of the printing fluid in the chamber 402 and therefore the pressure of the printing fluid inside the bag may be determined and the device 400 may therefore be used in examples where the printing fluid supply is to be changed (e.g. hot-swapping). For example, the printing fluid supply may comprise an intermediate tank with the inlet 403 being connected to air outside of the printing fluid bag (but inside the tank) and the inlet 406 being connected to the inside of the bag. As an intermediate fluid tank may be pressurised the device 400 allows the pressure of the printing fluid in the tank to be reliably determined.

The chamber to receive printing fluid may comprise a lower plastic base part and the membrane (which may comprise rubber) may be in contact with the printing fluid (at a lower side thereof, e.g. the side not retaining the magnet) and in this way may be flushed clean and filled with a different printing fluid easily. In this way the device is compatible with different fluids as it may be readily cleaned and since the magnet is not in contact with fluid (in examples where the membrane is to retain the magnet in a top, first, surface the magnet is may be in contact with the gas but not the fluid) and since the sensor is not in contact with fluid the sensing elements of the device are not in contact with the printing fluid thereby preserving their useful life.

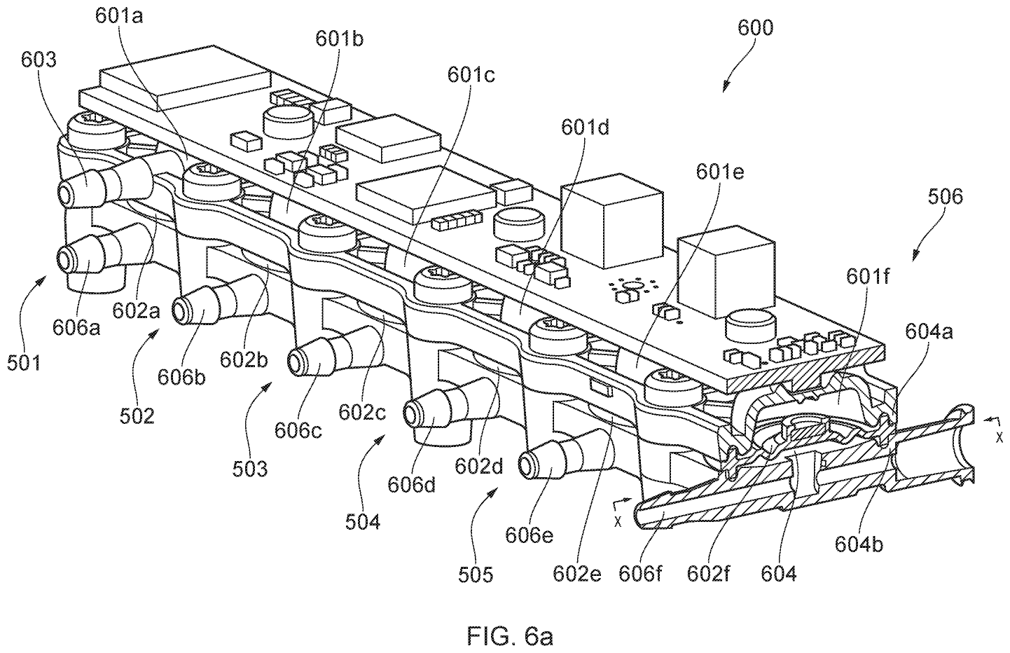

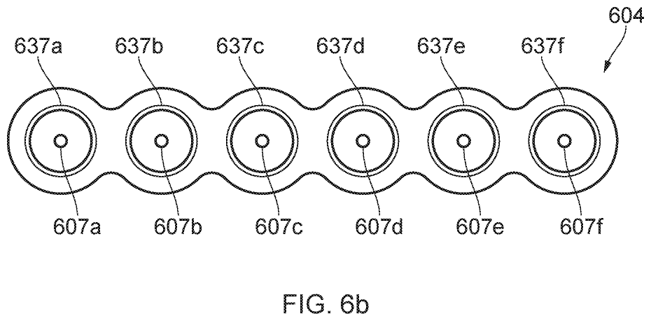

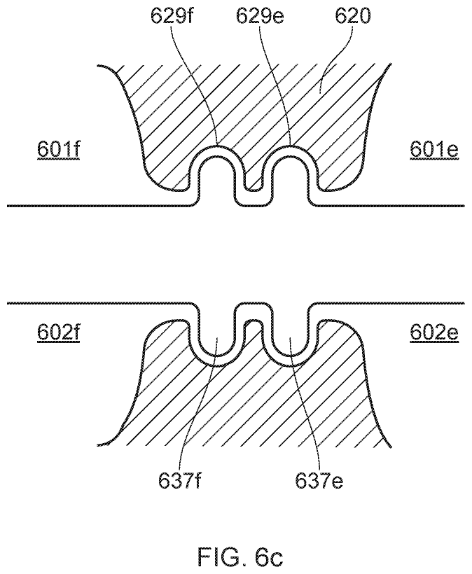

FIG. 6a shows one example device 600 comprising a plurality of devices 501-506, each one of the devices 501-506 comprising the device 100, 200, 300 or 400 as described above with respect to FIGS. 1-4. In other words, the device 600 comprises a composite device. Each device 501-506 comprises a respective first chamber 601a-f and second chamber 602a-f with each first chamber 601a-f being for the receipt of gas (e.g. pressurized gas) and each second chamber 602a-f being for receipt of a fluid whose pressure is to be measured by the device 600. The device 600 therefore comprises a pressure sensor comprising a plurality of first and second chambers 601a-f, 602a-f. The device 600 comprises a membrane 604 (shown through the cross-section of the device 506) which at least partially separates each first and second chamber in the plurality, with each first chamber 601a-f being disposed on the first side 604a of the membrane 604 and each second chamber 602a-f being disposed on the second side 604b of the membrane 604. In other words, the membrane 604 runs the length of the device 600. This is shown in FIG. 6b.

FIG. 6b shows the membrane 604 of the device 600. The membrane 604 comprises plurality of a cavities 607a-607f, each cavity for receipt of a magnet, and one cavity for each device 501-506. The membrane 604 is therefore to retain a plurality of magnetic elements, the membrane 604 being to retain each magnetic element in a position between respective first and second chambers. In this example the membrane 604 comprises an integral membrane but in other examples each device 501-506 may comprise a plurality of distinct, unconnected, membrane and, in these examples, each membrane may comprise a unique composition and/or geometry so that each device 501-506 is for a different pressure range allowing the device 600 to operate at a plurality of different pressure ranges. The device 600 may therefore comprise an upper housing for each first chamber 601a-f and a lower housing for each second chamber 602a-f.

Referring again to FIG. 6a, each of the plurality of first chambers 601a-f are fluidly connected. The device 600 comprising an inlet 603 to receive a pressurized gas, the inlet being fluidly connected to the plurality of first chambers 601a-f. In this way the inlet 603 supplies gas to each chamber 601a-f and the device 600 may comprise a single inlet 603 for the receipt of a gas. In other words, the first chambers 601a-f may be considered to be a single chamber which may be provided in a lid of the device. In these examples, to fluidly connect each of the first chambers 601a-f, each first chamber 601a-f (e.g. the housing thereof) comprises a connecting path, or conduit, such that each chamber 601a-f of each of the devices 501-506 is fluidly connected to another (e.g. to an adjacent chamber and therefore to an adjacent device), such that any gas that is directed into the chamber 601a (and therefore the device 501) via the inlet 603 is permitted to pass into each chamber 601a-f of each other device 502-506. Such a connecting path may comprise a passage and may be formed in the housing of the chamber 601 or device. The chambers themselves may comprise the connecting path or the housings may comprise the connecting path. In these examples, the first device 501 and last device 506 in the composite device 600 may comprise one connecting path to enable fluid connection between the first chamber 601a, 601f of those devices with the first chamber 601b, 602e, of an adjacent device 502, 505, the devices 501 and 506 being the end devices of the composite device 600. In this example, those in-between devices 502-505 may each comprise two connecting paths, each connecting path enabling a fluid connection between the first chamber 601b-e of those devices with the first chambers 601a-f of the two adjacent devices to those devices (e.g. to enable fluid communication with the two adjacent devices either side of a respective device). For example, device 501 may comprise a connecting passage enabling the first chamber 601a of device 501 to communicate with the first chamber 601b of device 502, and device 502 may comprise a first connecting passage enabling the first chamber 601b to fluidly communicate with the first chamber 601a of device 501 and a second connecting passage enabling the first chamber 601b to fluidly communicate with the first connecting passage 601c of device 503), etc.

By contrast, each device 501-506 comprises its own inlet 606a-f for fluid whose pressure is to be measured. This means that the device 600 can use the same control gas to obtain a plurality of measurements for a printing fluid thereby increasing confidence in the reliability of the measurement and can also measure the pressure of printing fluid in up to six printing fluid lines. Each chamber 602a-f of the device 600 is therefore formed between a housing of the device and the membrane 604. It should however be understood however that although the composite device 600 is shown having six component devices 501-506 this is for example and illustrative purposes. In other examples the device 600 may comprise any number of devices 501-506 (e.g. other than six). The device 600 comprises a PCA and in some examples the PCA comprises a sensor for each device 501-506, each sensor being to detect the magnetic field changes from the movement of a respective magnet of a respective device 501-506. In this way, the example device 600 comprises an array of devices and an array of sensors using the same base, lid and PCA to provide multiple (in this example, six) printing fluid channels and so the components to obtain a plurality of measurements may thereby be minimised. As above, each inlet may comprise a luer connection or barbed-connection or one-way valve etc., for example to permit the ingress and prevent the egress of fluid.

Referring again to FIG. 6b and additionally to FIG. 6c which shows a cross-section through device along the line X-X in FIG. 6a, the membrane 604 comprises a plurality of flanges 437. A housing 620 of the device 600 (a common housing for each device 501-506) comprises a groove 629 (e.g. any of 620a-f) in a portion of the housing separating adjacent first chambers or adjacent second chambers, the groove being complementarily sized and shaped to receive the flange 637 such that, when the flange 637 is received in the groove 629, the housing 620 is to retain the membrane in between a respective pair of first and second chambers. The membrane 604 may comprise a plurality of flanges 637a-f, each flange surrounding a respective cavity 607a-f, and the housing 620 may comprise a plurality of grooves 629a-f, each groove 629a-f to receive a respective flange 638a-f, as shown in FIG. 6c.

As stated hereinbefore, some example devices and/or sensors disclosed herein may be used in conjunction with a printing fluid tank, such as an intermediate ink tank, where any air surrounding the printing fluid bag inside the tank may be directed to the first fluid chamber for pressurized gas and fluid inside the bag may be directed to the second fluid chamber. In this way, the devices herein may be for use with a printer, for example an inkjet printer, and the devices may allow the printer to measure or verify the printing fluid pressure, preventing issues such as printhead overheating, component malfunction, degradation of the printed image output and potential printhead failure, that may arise from a lack of ink pressure, or component damage or the shortening of the useful component life or ink leakage that may arise from an over pressure. As the device's moving parts may comprise the membrane/flexible element (which as stated above may comprise a resiliently deformable element such as rubber, e.g. synthetic rubber) having a general resistance to deformation, the devices herein are resistant to fatigue or mechanical wear/degradation. Furthermore, where the device is used in conjunction with a printer the device may not be affected by vibrations experienced during printing due to the low harmonic resonance of the membrane. Devices herein may therefore provide a low-cost, reliable and durable fluid sensor. The sensor construction furthermore allows for renewal of the fluid in the sensor device as the fluid flows through it, preventing issues such as printing fluid expiration or fluid property degradation over time, in addition to allowing for air purging when first priming the system.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A printing fluid pressure sensor comprising:
a first pressurizable chamber having an inlet to receive a pressurized gas;
a second chamber to receive a printing fluid;
a flexible element disposed in between the first and second chambers, a first side of the flexible element forming a wall of the first chamber and a second side of the flexible element forming a wall of the second chamber to seal the first and second chambers, wherein the flexible element is to retain a magnet;
a sensor to detect the position of a magnet relative to the sensor, the sensor being disposed outside of the first and second chambers.

2. The printing fluid pressure sensor of claim 1, wherein the flexible element comprises a recess on the first side of the flexible element to retain the magnet, wherein the recess is not exposed to the second chamber such that, when a magnet is received in the recess and when printing fluid is received in the second chamber, the magnet and printing fluid are not in contact.

3. The printing fluid pressure sensor of claim 2, wherein the recess is exposed to the first pressurizable chamber.

4. The printing fluid pressure sensor of claim 1, wherein the sensor is disposed such that the first chamber is in between the sensor and the flexible element.

5. A pressure sensor for determining the pressure of a printing fluid, the sensor comprising:
a housing;
a membrane disposed at least partially inside the housing separating first and second chambers on respective first and second sides of the membrane, the membrane forming a seal with the housing to seal the first and second chambers, wherein the first chamber is a pressurizable chamber for receipt of a pressurized gas and wherein the second chamber is for receipt of a printing fluid, wherein the membrane is to retain a magnetic element; and
a magnetic field sensor to detect movement of the magnet, the magnetic field sensor being disposed in or outside of the housing.

6. The pressure sensor of claim 5 wherein the membrane comprises a cavity to retain the magnetic element such that the magnetic element is not exposed to the second chamber.

7. The pressure sensor of claim 5 wherein the magnetic field sensor is disposed on the side of the membrane facing the first chamber.

8. The pressure sensor of claim 5 wherein the membrane comprises a flange and wherein the housing comprises a groove, the groove being complementarily sized and shaped to receive the flange such that the housing is to retain the membrane when the flange is received in the groove.

9. The pressure sensor of claim 5 comprising a plurality of first and second chambers, wherein the membrane at least partially separates each first and second chamber in the plurality, each first chamber being disposed on the first side of the membrane and each second chamber being disposed on the second side of the membrane,
wherein the magnetic element comprises a plurality of magnetic elements, the membrane being to retain each magnetic element in a position between respective first and second chambers.

10. The pressure sensor of claim 9, wherein each of the plurality of first chambers are fluidly connected, and wherein the sensor further comprising an inlet to receive a pressurized gas, the inlet being fluidly connected to the plurality of first chambers.

11. The pressure sensor of claim 9, wherein the membrane comprises a flange and wherein the housing comprises a groove in a portion of the housing separating adjacent first chambers or adjacent second chambers, the groove being complementarily sized and shaped to receive the flange such that, when the flange is received in the groove, the housing is to retain the membrane in between a respective pair of first and second chambers.

12. A pressure sensing device for printing fluid comprising:
a pressurizable gas chamber for receipt of pressurized gas;
a printing fluid chamber for the receipt of printing fluid;
a resiliently deformable element separating the gas chamber and the printing fluid chamber and comprising first and second sides;
a device housing comprising a first housing portion for the gas chamber, the first housing portion having an inlet to receive pressurized gas, and a second housing portion for the printing fluid chamber;
wherein the first side of the resiliently deformable element and the first housing portion form a housing defining the gas chamber and wherein the second side of the resiliently deformable element and the second housing portion form a housing defining the printing fluid chamber;
wherein the resiliently deformable element is to hold a magnetic element and wherein the pressure sensing device comprises a sensor to detect movement of the magnetic element.

13. The pressure sensing device of claim 12 wherein the first housing portion comprises the sensor.

14. The pressure sensing device of claim 13 wherein the first side of the resiliently deformable element comprises an opening to hold the magnetic element.

15. The pressure sensing device of claim 12 wherein the resiliently deformable element is retained by the housing by virtue of engagement between a protrusion of the resiliently deformable element and a recess in the housing.
